(19) United States
(12) Patent Application Publication
(10) Pub. No.: US 2014/0164404 A1
(43) Pub. Date: Jun. 12, 2014

(54) METHOD AND APPARATUS FOR PROVIDING PROXY-BASED CONTENT RECOMMENDATIONS

(71) Applicants: Francis Edward Simon HUNT, Naperville, IL (US); Won TCHOI, Schaumburg, IL (US); Sean MURPHY, St. Charles, IL (US)

(72) Inventors: Francis Edward Simon HUNT, Naperville, IL (US); Won TCHOI, Schaumburg, IL (US); Sean MURPHY, St. Charles, IL (US)

(73) Assignee: Nokia Corporation, Espoo (FI)

(21) Appl. No.: 13/709,835

(22) Filed: Dec. 10, 2012

(51) Int. Cl. G06F 17/30

(52) U.S. Cl. CPC G06F 17/30595
USPC 707/754; 707/736

(57) ABSTRACT

An approach is provided for proxy-based content discovery and delivery. A proxy platform determines usage information for at least one user of a proxy server. The usage information includes, at least in part, browser history information, web application data usage information, or a combination thereof determined by the proxy server to be associated with the at least one user. The proxy platform processes and/or facilitates a processing of the usage information to determine at least one user profile for the at least one user. The proxy platform then determines one or more recommendations for the at least one user based, at least in part, on the at least one user profile.

### BACKGROUND

Wireless (e.g., cellular) service providers and device manufacturers are continually challenged to deliver value and convenience to consumers by, for example, providing compelling network services, applications, and content. As a result, the variety and choice web-based services, applications, and content have increased exponentially, thereby making it more difficult for users to discover content of interest. At the same time, the use of mobile devices for accessing web service, applications, and content is also increasing. However, limited resources (e.g., bandwidth, processing power, availability of the mobile web server) within the wireless environment can limit access to these web services on mobile devices. Accordingly, service providers and device manufacturers face significant technical challenges to overcome such limitations by enabling efficient and secure discovery and access to web services, applications, and content via, for instance, a proxy server.

### SOME EXEMPLARY EMBODIMENTS

Therefore, there is a need for an approach for providing proxy-based content recommendations.

According to one embodiment, a method comprises determining usage information for at least one user of a proxy server. The usage information includes, at least in part, browser history information, web application data usage information, or a combination thereof determined by the proxy server to be associated with the at least one user. The method also comprises processing and/or facilitating a processing of the usage information to determine at least one user profile for the at least one user. The method further comprises determining one or more recommendations for the at least one user based, at least in part, on the at least one user profile.

According to another embodiment, an apparatus comprises at least one processor, and at least one memory including computer program code, the at least one memory and the computer program code configured to, with the at least one processor, cause, at least in part, the apparatus to determine usage information for at least one user of a proxy server. The usage information includes, at least in part, browser history information, web application data usage information, or a combination thereof determined by the proxy server to be associated with the at least one user. The apparatus is also caused to process and/or facilitate a processing of the usage information to determine at least one user profile for the at least one user. The apparatus is further caused to determine one or more recommendations for the at least one user based, at least in part, on the at least one user profile.

According to another embodiment, a computer-readable storage medium carries one or more sequences of one or more instructions which, when executed by one or more processors, cause, at least in part, an apparatus to determine usage information for at least one user of a proxy server. The usage information includes, at least in part, browser history information, web application data usage information, or a combination thereof determined by the proxy server to be associated with the at least one user. The apparatus is also caused to process and/or facilitate a processing of the usage information to determine at least one user profile for the at least one user. The apparatus is further caused to determine one or more recommendations for the at least one user based, at least in part, on the at least one user profile.

According to another embodiment, an apparatus comprises means for determining usage information for at least one user of a proxy server. The usage information includes, at least in part, browser history information, web application data usage information, or a combination thereof determined by the proxy server to be associated with the at least one user. The apparatus also comprises means for processing and/or facilitating a processing of the usage information to determine at least one user profile for the at least one user. The apparatus further comprises means for determining one or more recommendations for the at least one user based, at least in part, on the at least one user profile.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of providing proxy-based content recommendations, according to one embodiment;

FIG. 2 is a diagram of components of a proxy platform capable of providing proxy-based content recommendations, according to one embodiment;

FIG. 3 is a flowchart of a process for providing proxy-based content recommendations, according to one embodiment;

FIGS. 4A-4G are diagrams of user interfaces utilized in the processes of FIGS. 1-3, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile station (e.g., handset) that can be used to implement an embodiment of the invention.

### DESCRIPTION OF PREFERRED EMBODIMENT

A method and apparatus for providing proxy-based content recommendation are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to providing proxy-based content recommendations within a wireless network environment, it is contemplated that the various embodiments of the approach described herein may be used within any type of communication system or network and with any mode of communication available of the network (e.g., data communications, Internet communication, voice communication, text communication, etc.). In addition, although the various embodiments are further described with respect to mobile devices, it is contemplated that the various embodiments are applicable to any type of device with network access (e.g., stationary terminals, personal computers, etc.).

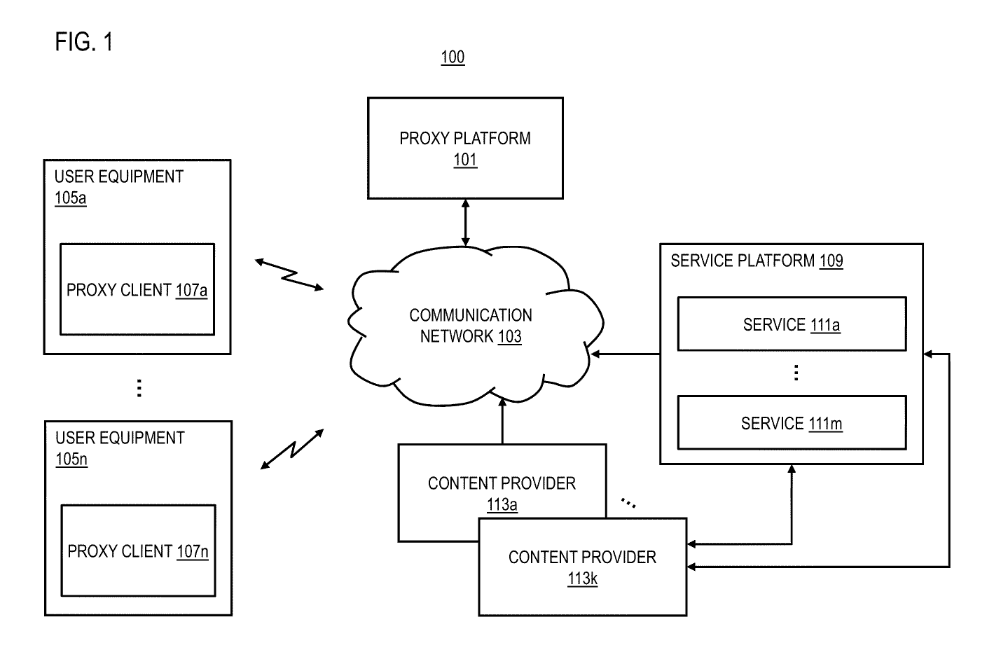

FIG. 1 is a diagram of a communication system capable of providing proxy-based content recommendations, according to one embodiment. As the amount of web content (e.g., web pages, web services, and web applications) increases, users are finding it more difficult to discover new content of interest. For example, even though there currently are tens of billions of web pages available over the Internet, many users limit themselves to visiting only a small fraction of web pages that they have become familiar with. As a result, many users miss out on the vast amount of content available over the remaining tens of billions of web pages that those users may never visit. Accordingly, service providers and device manufactures face significant technical challenges to enabling discovery of new web content.

Traditionally, methods for consumers to discover relevant web content have been limited. For example, one traditional method requires that the user have prior knowledge of the web page the user is looking for, or at least require that the use know keywords related to the type of content the user is seeking. The assumption in this case is that the user knows what the user wants, and just needs a way to find it. Under this scenario, users can enter the web page address (e.g., a URL) directly into a web browser or perform a search based on keywords for the use case the user has in mind.

Another traditional method involves the use of content aggregation services such as web portals, blog sites, and subscription feed (e.g., RSS feeds) aggregators. In this method, the user accesses to the content aggregation service through a web browser or standalone application to discover relevant content. However, content filtering and/or recommendations are generally limited to using information available only within the specific aggregation service. Similarly, content discovery can be performed through social networking services via content sharing or recommendation among social networking users.

However, these traditional methods have relied on only a limited set of information about a user. For example, the first method described above depends on prior knowledge of the user which may be limited. The second content aggregation service method relies on information generally available only in the service. The third social networking based content discovery method relies on information (e.g., sharing and recommendations) available from only the participating users.

In summary, these methods lack a holistic approach to content discovery and recommendation. As a result, the recommendations provided by these methods can be less relevant because they are based on a limited set of usage information. In the case of solutions that make use of user configuration, the solutions may be unable to provide relevant recommendations of content that are outside of the parameters configured by the user. For example, users often do not configure all the categories that are relevant to them due to the amount of effort required or due to a disconnect between their understanding of the their interests and their actual browsing patterns. Typically, it is also difficult for a user to alter configured parameters to match the user's mood in the current moment. For example, although a user may have nominated “sports” as the user's category of interest yesterday, the user may be more interested in “finance” today.

To address at least these problems, a system 100 of FIG. 1 introduces a capability to improve the relevance and ease of web content discovery by leveraging the user browser history and/or other web application data usage available within a proxy platform 101 (e.g., a web proxy server). In one embodiment, the system 100 leverages the complete user browser history and web application data usage collected by the proxy platform 101 for individual users. For example, the proxy platform 101 tracks and analyzes over the communication network 103 the usage patterns for individual users operating respective user equipment (UEs) 105a-105n (also collectively referred to as UEs 105) to access web content via the proxy platform 101. In one embodiment, the UEs 105 include respective proxy clients 107a-107n (also collectively referred to as proxy clients 107) to interact with the proxy platform 101 and respond to user request for web content via the proxy platform 101.

In one embodiment, the proxy platform 101 processes the usage patterns or usage information to automatically recommend web content that is most relevant to the individual user. By way of example, the web content includes, but is not limited to, web pages, videos, photographs, music tracks, applications (e.g., both native and web-based applications), and/or any other content accessible via the proxy platform 101. As a result, the proxy platform 101 is able to make recommendations with respect to linked web content items (e.g., URLs to recommended stores) as well as with respect to new applications and/or services for the user to discover. In one embodiment, the proxy platform 101 processes the usage information determine user behavior and/or preferences, and then associates with these behaviors with specific content types. The proxy platform 101 then uses the behaviors, preferences, content associations, and related information to make relevant content recommendations.

In one embodiment, the content recommendations are drawn from aggregating related historical activity (e.g., usage information) from activity of all or a reference set of users of the proxy platform 101. In this way, the proxy platform 101 need not require active configuration or participation by the user to determine content recommendations. Nonetheless, in one embodiment, the proxy platform 101 may optionally use any active configuration or participation by the user or other individuals to further enhance the recommendations provided by the proxy platform 101.

As noted above, in one embodiment, the proxy platform 101 is based on web proxy server technology. For example, a web proxy server supports the processing of web pages and other web content for the proxy clients 107 (e.g., web browsers or other web-based applications). In one embodiment, a proxy web browser is one where the rendering of a web page (e.g., HTML, CSS, JavaScript, etc.) is performed remotely by a web proxy server (e.g., the proxy platform 101) on behalf of a requesting client application (e.g., the proxy client 107). In on embodiment, the proxy client 107 can be a complete web browser, a simplified version of a web browser, or any other web-based application. Whenever, the proxy client 107 requests to load a web page or access web content, the proxy platform 101 loads the web page or content from the a web server or other communication endpoint, renders it, and returns the rendered content back to the proxy client 107.

By way of example, the web servers or communication endpoints accessible via the proxy platform 101 can include or be provided by a service platform 109, the services 111a-111m (also collectively referred to as services 111), the content providers 113a-113k (also collectively referred to as content providers 113), or any other component with connectivity to the communication network 103 (e.g., another UE 105). For example, the service platform 109, the service 111, and/or the content providers 113 may provide any number of services, applications, etc. (e.g., mapping services, social networking services, media services, content services, etc.) via a web server or other means of communications (e.g., text messaging, voice, instant messaging, chat, etc.). In other words, the communication endpoints represent a terminating point of communications from the proxy clients 107, and an originating point of communications to the proxy clients 107. In this case, the usage information processed by the proxy platform 101 include, at least in part, browser history information, web application data usage information, and/or any other recordable user interactions of the UEs 105 and their respective proxy clients 107 with the communication endpoints or resources available via the proxy platform 101 and/or the communication network 103.

In the case of web-based applications, the proxy platform 101 provides optimization and compression of web content to reduce the payload size and improve performance (e.g., reduced latency, bandwidth usage, etc.). In one embodiment, the proxy platform 101 has a detailed record of the usage history or information of web-based applications that are supported by the proxy platform 101 or otherwise accessed via the proxy platform 101. For example, many modern web-based services and applications (e.g., maps, music, video, electronic books, etc.) can be quite data intensive and involve transfers of significant amounts of data between client device and the services. As a result, loading or access times associated with the web services, applications, and related content can be significant, particularly in mobile wireless environments where bandwidth and device resources can be limited. By way of example, loading times includes, at least in part, a combination of: (1) a browser or client startup time on the device, (2) the time it takes for the browser or client to initiate a network connection, and (3) the time it takes to load the actual content. In each of the three areas, the relatively limited resources of mobile device operating within a wireless environment can result in extended load times which can discourage users from accessing such web services or content.

The proxy platform 101 addresses these issues. For example, as previously described, the proxy clients 107 operate in coordination with the proxy platform 101 which access web or network content on behalf of the proxy clients 107. In one embodiment, the proxy platform 101 receives requests from the proxy clients 107 to route communication traffic to requested communication endpoints and/or resources (e.g., websites, services, applications, etc. available over the communication network 103) of the proxy platform 101. In addition, the proxy platform 101 can route return communication traffic from the communication endpoints or resources to the any of the proxy clients 107 and/or UEs 105. In one embodiment, the proxy platform 101 tracks and monitors these communication interactions to generation usage information (e.g., consisting of browser history information and/or web application data usage information) that includes, at least in part, a record the requested communication endpoints and/or resources (e.g., web content) and the related communication traffic originating and/or terminating there from.

In one embodiment, the proxy platform 101 identifies an accessing proxy client 107 on an individual user basis and tracks the network access information or history associated with the proxy client 107. For example, if a user of the proxy client 107 visits a certain website or communication endpoint daily, the proxy platform 101 records the access information or behavior with respect to the website, and provide for automatic generation of user profile and/or behavior patterns for determining proxy-based content recommendations.

In another embodiment, the system 100 enables use of social features to enhance content recommendation, discovery, and delivery at the proxy clients 107. More specifically, the system 100 enables the proxy platform 101 to monitor usage information and/or access histories associated with other users (e.g., friends, colleagues, family, all users, etc.) to determine what content to recommend to the proxy client 107. In other words, various embodiments of the approach described herein can be expanded so that if a number of a user's friends or users who share similar profiles or behaviors visit a specific site, the proxy platform 101 can push or transmit a notification to the user's proxy client 107 to recommend potential sites or content of interest.

In one embodiment, the proxy platform 101 can stratify usage information to determine user profiles, behaviors, etc. according to various contextual parameters (e.g., time, location, activity, etc.). For example, the proxy platform 101 can determine different user profiles or behaviors under different contextual granularities (e.g., location granularities ranging from nearby proximity, neighborhood, city, state, country, all locations, etc.). In this way, the proxy platform 101 can provide more contextually relevant recommendations to users.

In one embodiment, the contextual parameters may be determined from one or more sensors associated with the UE 105, the proxy platform 101, and/or other component of the system 100. For example, the sensors include, but are not limited to, environmental sensors, sensors for physical properties, material sensors, location sensors, health and wellness sensors, personal sensors, wireless sensors, wired sensors, virtual sensors, network sensors, and the like. In one embodiment, with respect to location, the location can be determined by a triangulation system such as a GPS system, assisted GPS (A-GPS), wireless local area network triangulation, or other location extrapolation technologies. Standard GPS and A-GPS systems can use satellites to pinpoint the location (e.g., longitude, latitude, and altitude) of the element. GPS coordinates can provide finer detail as to the location of the element.

In one embodiment, the proxy platform 101 also enables filtering of recommendations based, at least in part, on one or more filtering criteria. By way of example, filtering criteria may include contextual parameters (e.g., time, location, etc.) as well as topical criteria, social graph criteria, and the like. In this way, the proxy platform 101 enables a user to select the types and scope of recommendations to receive from the proxy platform 101.

In some embodiments, in addition to various embodiments of the process for content recommendation, discovery, and delivery described herein, the proxy platform 101 can perform any number of communications related functions for routing and/or processing communication traffic. For example, the proxy platform 101 may compress or otherwise modify content that is to be delivered to the proxy clients 107 based, at least in part, on one or more capabilities or characteristics of the receiving UE 105. For example, in wireless environments, the proxy platform 101 can compress data for more efficient transmission, transform content to reduce the amount of data for transfer, reformat content for display in smaller screens, etc.

By way of example, the UE 105 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 105 can support any type of interface to the user (such as “wearable” circuitry, etc.).

Additionally, the communication network 103 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

Communication is facilitated between the UE 105 and the proxy platform 101 via the communication network 103 using well known, new or still developing protocols. In this context, a protocol includes a set of rules defining how the network nodes within the communication network 103 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the proxy clients 107 and the proxy platform 101 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

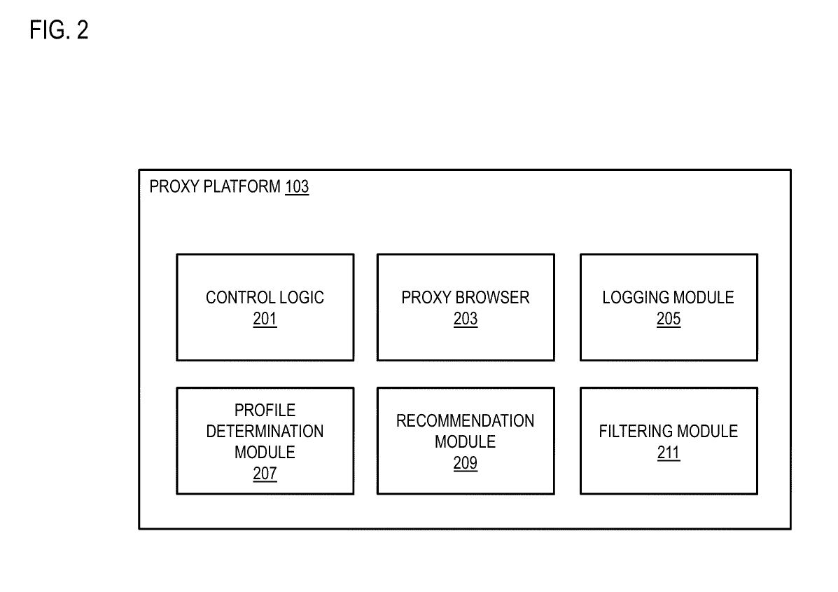

FIG. 2 is a diagram of components of a proxy platform capable of providing proxy-based content recommendations, according to one embodiment. By way of example, the proxy platform 101 includes one or more components for providing proxy-based content recommendation, discovery, and delivery. It is contemplated that the functions of these components may be combined in one or more components or performed by other components of equivalent functionality. In this embodiment, the proxy platform 101 includes a control logic 201, a proxy browser 203, a logging module 205, a profile determination module 207, a recommendation module 209, and a filtering module 211.

More specifically, the control logic 201 executes at least one algorithm for performing one or more functions of the proxy platform 101. For example, the control logic 201 interacts with the proxy browser 203 to respond to web content requests from one or more proxy clients 107 of the UEs 105. As discussed above, the proxy browser 203 is a network side component that remotely processes web pages and other web content on behalf of the proxy clients 107 (e.g., a web browser or other client application). In some embodiments, the proxy browser 203 shares distributed components for processing and delivering web content with the proxy clients 107. Accordingly, in some embodiments, the proxy clients 107 are client side components of the proxy browser 203 that renders displayable versions of a web document or other web content delivered by the proxy browser 203.

In one embodiment, the proxy browser 203 receives web content requests, retrieves the requested content from one or more web servers, and renders the content for delivery and presentation at the proxy clients 107. In other words, the proxy browser 203 and the proxy platform 101 sit in the path of all web traffic between the proxy platform 101 and the proxy clients 107.

In this way, the proxy browser 203 can interact with the logging module 205 track, monitor, and record usage information between the proxy clients 107 and the proxy platform 101 to generate a complete usage history for individual proxy clients 107. For example, if all browsing performed by a user of the UE 105 occurs through the proxy clients 107 and the proxy platform 101, the usage information collected by the logging module 205 can represent a substantially complete history of a user's browser history, web application data usage history, and other web activities occurring via the proxy platform 101. This usage information or history represents a broad collection of information that spans across all user activity that can span across multiple web sites, multiple web services, multiple web applications, and the like. In comparison, as discussed above, traditional approaches to usage information collect that are not proxy-server based typically are limited to information in specific domains or use cases such as search, social networking, video, etc.

In one embodiment, the logging module 205 retains a complete historical log of all users browsing and web application data usage occurring via the proxy browser 203. The log contains, for instance, data such as web pages viewed, web pages shared, web content downloaded, ratings provided such as likes, applications used, etc. In one embodiment, the logging module 205 can identify specific proxy clients 107 in order to maintain personal logs for each proxy client 107. In one embodiment, the proxy clients 107 identify themselves to the proxy platform 101 using, for instance, a unique identifier (e.g., associated with the proxy client 107, the UE 105, or a user of the UE 105). The logging module 205 can then log usage information occurring via the proxy platform 101 according to the unique identifier in order to differentiate individual users. It is contemplated that the proxy clients 107 may identify themselves using any means and/or unique identifiers (e.g., phone numbers, device identifiers, user name, user account, etc.).

As previously described, usage information includes information that indicates what communication endpoints and/or resources are accessed by the proxy clients 107. In one embodiment, the access information may include contextual information to indicate, for instance, when, where, how, etc. the communication endpoints or resources were accessed. In some embodiments, the usage information also provides, at least in part, indications of whether access to one or more elements of the access history (e.g., communications endpoints or resources) was granted, denied, or otherwise restricted to one or more of the accessing proxy clients 107. For example, access information may include flags indicating whether a particular communication endpoint, resource (e.g., a website, a phone number, a test messaging number, etc.), or proxy client 107 is associated with objectionable material, malicious content, fraudulent content, and/or other potential risks. In addition or alternatively, access information may include experience that indicates one or more communication endpoints, resources, or proxy clients 107 are free or substantially free from known threats.

Following aggregation of usage information for one or more users, the control logic 201 of the proxy platform 101 interacts with the profile determination module 207 to develop an automated profile of the user, UE 105, or proxy client 107 associated with a specific usage information log. In one embodiment, the profile determination module 207 operates without active user configuration or participation. Instead, the profile determination module 207 processes collected usage information (e.g., browser history information, web application data usage information, etc.) to create a user profile that contains a representation of the user's behaviors, preferences, etc. with respect to certain types of content (e.g., web pages, videos, photographs, music tracks, applications, etc.).

For example, the profile determination module 207 analyzes the usage information to discover: (1) what the user/other users do on the web including, for instance, browsing, sharing, application use, streaming, downloading, etc.; (2) what content the user/other users use on the web including, for instance, web sites, videos, categories of content, levels of content, etc.; (3) what content the user/other users generate on the web including, for instance, likes, recommendations, mashups, start pages, uploads, cloud storage, etc.; and the like. In one embodiment, content can include any item accessible (e.g., via a link or URL) through the proxy platform 101. For example, content may include web page content such as text, graphics, multimedia items embedded within web pages, and the like. In addition, content may include digital content items (e.g., images, videos, audio tracks, electronic books, audio books, applications, services, etc.) that can be obtained or otherwise accessed through the proxy platform 101. For example, the proxy platform 101 may enable access to online content stores (e.g., media stores, application stores, image repositories, etc.) through which a user can access different types of content items. Accordingly, the profile determination module 207 can track what content is accessed and in some embodiments, under what contexts the content is accessed. In one embodiment, metadata associated with the content (e.g., genre, topic, category, etc.) may also be tracked to provide additional information on accessed content to build a user profile. Accordingly, the profile determination module 207 can evaluate these types of usage information against presence or contextual information (e.g., location, time, context, situation, etc.) to generate a user profile that describes a user's behavior and/or preferences with respect to various types of web content.

It is contemplated that the profile determination module 207 can use any type of algorithm to process the usage information into a user profile. For example, the profile determination module 207 can use an algorithm that is based on frequency of occurrence or access of certain types of content by a user. In one embodiment, the algorithm may provide different weights for preferences or behaviors based on contextual information (e.g., time or location). For example, a user may have a different set of behaviors or preferences on a weekend day as compared to a non-weekend day.

By way of example, in one use case, the profile determination module 207 may apply algorithms to determine a user's favorite color from the analyzing the characteristics of the content that the user has accessed. For example, the profile determination module 207 can evaluate what colors are most often accessed by a user when viewing photographic content. The profile determination module 207 can then extrapolate that the most frequently occurring color represents the user's favorite color. Similarly, the profile determination module 207 may apply topical analysis of textual content parsed from a user's accessed content to determine preferences or profile information. For example, if a topical analysis of visited content shows a prevalence of topics related to chocolate, the profile determination module 207 may designate chocolate as a preference for the user. In one embodiment, the profile determination module 207 may apply the algorithms to determine preferences to a degree of probability or based on a minimum number of topics (e.g., top 10 preferences or profile categories) to characterize a user.

After determining user profiles for users of the proxy platform 101, the control logic 201 interacts with the recommendation module 209 to process the user profiles to make proxy-based content recommendations. In one embodiment, the recommendation module 209 takes into account the complete usage history (e.g., as captured in the user profile) of the user to help predict usage behaviors, patterns, preferences, etc. to determine more relevant content recommendations.

In one embodiment, the recommendation module 209 uses the user profiles to locate relevant web content that at least substantially match the user's profile. In one embodiment, the association between specific profiles and relevant web content can be determined for the aggregate usage information for all users or a set of reference users available in the proxy platform 101. In one embodiment, the relationship between users with similar profiles can also be used to make relevant content recommendations.

In one embodiment, it is contemplated that the recommendation module 209 may use any type of algorithm to make proxy-based content recommendations based on user profiles, usage information, browsing history, web application data usage information, etc. By way of example, in one embodiment, the recommendation module 209 may use rule-based recommendation algorithms to determine proxy-based content recommendations. Rule-based recommendation algorithms use, for instance, one or more rule sets that specify what recommendations to make given a set of conditions or inputs. In this case, the conditions or inputs may correspond to specific user profiles, behaviors, or preferences determined from usage information at the proxy platform 101.

In another embodiment, the recommendation module 209 may use a collaborative filtering based recommendation to make proxy-based content recommendations from collected usage information. In one embodiment, collaborative filtering recommendation algorithms analyze relationships between users (e.g., via user profiles, behaviors, preferences, etc.) to determine interdependencies between the users among a set of web content items to create new user-item associations. These user-content item associations can then be used to make proxy-based content recommendations.

In one embodiment, the recommendation module 209 can make recommendations that can span the entire spectrum of content accessible through the proxy platform 101 including recommending individual links to specific content items (e.g., URL of web pages) as well as recommending the applications and/or services available through the proxy platform 101. For example, based on usage information, the recommendation module 209 may recommend that a user download or use a specific application or service (e.g., social networking application, a photo sharing application, a mail application, etc.) that is compatible with the user's profile. In this way, the recommendation module 209 can generate recommendations for individual content items as well as applications/services.

After determining one or more content recommendations, the control logic 201 interacts with the filtering module 211 to enable filtering of content recommendations according to one or more filtering criteria. For example, the filtering module 211 enables filtering of recommendations by time, location, topic, social graph connections, etc. This enables users to further refine the recommendations based on contextual parameters. For example, users can determine filter recommendations to show those recommendation most appropriate for a given time or location. In one embodiment, the filtering can also be performed at different granularities of the filtering criteria. For example, different granularities of time may correspond to recommendations for a particular hour, day, week, month, season, year, etc.

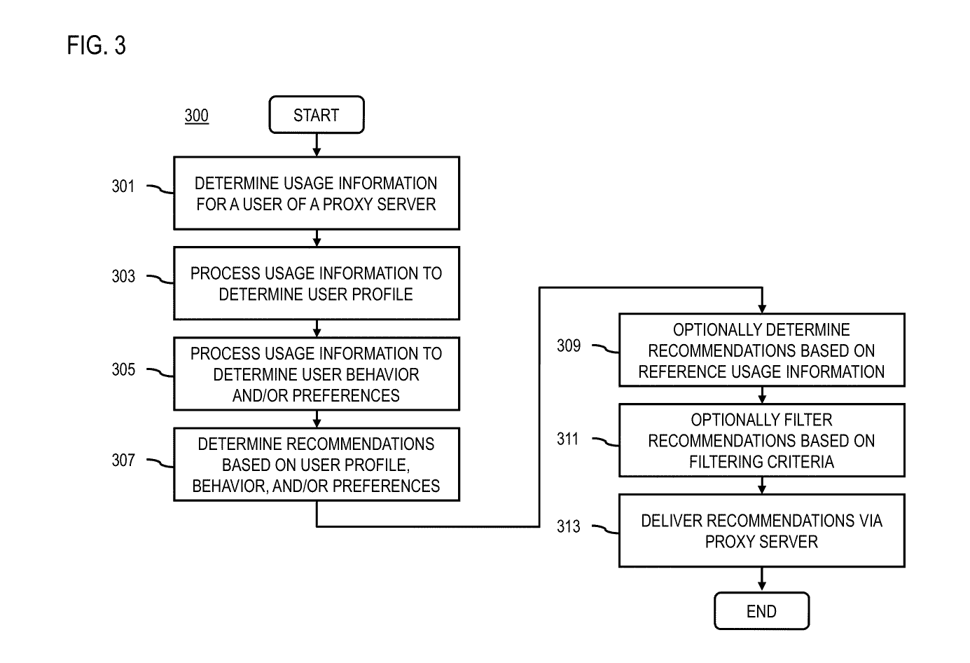

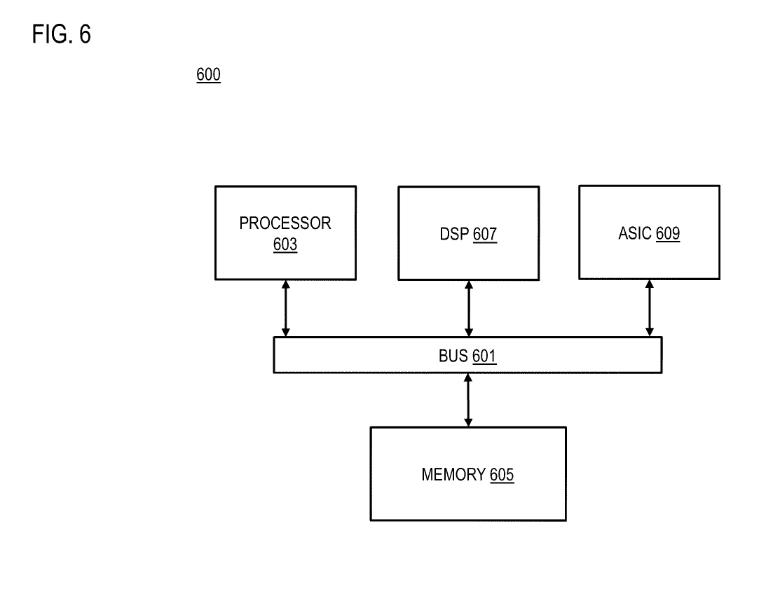

FIG. 3 is a flowchart of a process for providing proxy-based content discovery and delivery, according to one embodiment. In one embodiment, the proxy platform 101 performs the process 300 and is implemented in, for instance, a chip set including a processor and a memory as shown FIG. 6.

In step 301, the proxy platform 101 determines usage information for at least one user (e.g., via a proxy client 107) of a proxy server (e.g., a proxy platform 101), wherein the usage information includes, at least in part, browser history information, web application data usage information, or a combination thereof determined by the proxy platform 101 to be associated with the at least one user or proxy client 107. In one embodiment, the usage information represents a substantially complete log of the browser history information, the web application data usage information, or a combination thereof determined by the proxy platform 101. In embodiment, the usage information is determined across a plurality of web content sources, a plurality of web applications, or a combination thereof. As previously noted, the proxy platform 101 collects the usage information automatically as a user or group user access web content via the proxy platform 101. This provides an automated collection process without specific user configuration or participation.

In one embodiment, the proxy platform 101 determines the usage information, the reference usage information, or a combination thereof based, at least in part, on one or more inputs from the at least one user, the one or more reference users, or a combination thereof. For example, the proxy platform 101 may enable users to actively configure or specify usage information (e.g., browser history information, web application data usage information, etc.) and their association with particular types of preferred content. In this way, if the user wants to supplement the automated determination of usage information performed by the proxy platform 101, the user need only input such association information.

In some embodiments, the proxy platform 101 also determines contextual information associated with the usage information, the proxy client 107, or a combination thereof. In this way, the proxy platform 101 categorizes the usage information based on user context or presence. For example, if the contextual information indicates that a user frequently accesses a web resource (e.g., a news website) on most weekdays at approximately 8:00 am, the proxy platform 101 can associate the user behavior with the observed context. Similarly, if the context information that when the a user enters a particular location (e.g., a shopping mall, home, etc.), the user frequently accesses a particular website (e.g., a coupon website), the proxy platform 101 can determine location information associated with the corresponding proxy client 107 and characterize the usage information with the observed context (e.g., location). Accordingly, in one embodiment, the proxy platform 101 can log usage information based on context to enable more relevant recommendations for the particular context.

In step 303, the proxy platform 101 processes and/or facilitates a processing of the usage information to determine at least one user profile for the at least one user. As noted above, the user profile may include information including user behavioral patterns, preferences, etc. as analyzed or determined from the collected usage information. For example, in step 305, the proxy platform 101 processes and/or facilitates a processing of the usage information to determine one or more user behavioral patterns, one or more user preferences, or a combination thereof with respect to web content available via the proxy server. In one embodiment, the web content includes, at least in part, one or more web pages, one or more videos, one or more photographs, one or more audio tracks, one or more applications, or a combination thereof.

In one embodiment, the at least one user profile, as well as one or more recommendations arising from the at least one user profile, or a combination thereof are further based, at least in part, one or more user behavioral patterns, the one or more user preferences, or a combination thereof.

In step 307, the proxy platform 101 determines one or more recommendations for the at least one user based, at least in part, on the at least one user profile. In step 309, the proxy platform 101 optionally determines the recommendations based on reference usage information. More specifically, the proxy platform 101 determines reference usage information for one or more reference users of the proxy server. By way of example, the one or more reference users may include all or a subset of the users of the proxy platform 101. The selection of the number of reference users to use can be based on amount of available usage data, available computational resources, processing time, and the like. The proxy platform 101 then processes and/or facilitates a processing of the reference usage information to determine one or more associations between the one or more reference behavioral profiles of the one or more reference users and one or more reference web content items (e.g., including URL links and/or recommended applications/services). Next, the proxy platform 101 determines the one or more recommendations for the at least one user based, at least in part, on the one or more associations. In other words, the proxy platform 101 can determine a standard set of reference profiles and their associations with particular web content items. The proxy platform 101 can then find the closest match between a user profile for a user who is to receive a recommendation, and a reference user profile of one of the reference users. Then the proxy platform 101 can recommend the web content associated with or preferred by the matching reference user.

In step 311, the proxy platform 101 optionally causes, at least in part, a filtering of the one or more recommendations based, at least in part, on one or more filtering criteria. In one embodiment, the one or more filtering criteria include, at least in part, a time criterion, a location criterion, a topic criterion, a social graph criterion, or a combination thereof. In one embodiment, the filtering criteria can be considered as recommendations channels whereby a user can specify criteria for determining which “channel” or category of recommendations is most interesting to the user at a particular moment. In one embodiment, the “channel” is created from recommendations that meet the filtering criteria. For example, if a filtering criterion specifies “near me”, the corresponding recommendation channel will present only those recommendations associated with locations nearby the user. Similarly, if a filtering criterion specifies “social”, the corresponding recommendation change will present only those recommendations associated with members of the user's social graph or network.

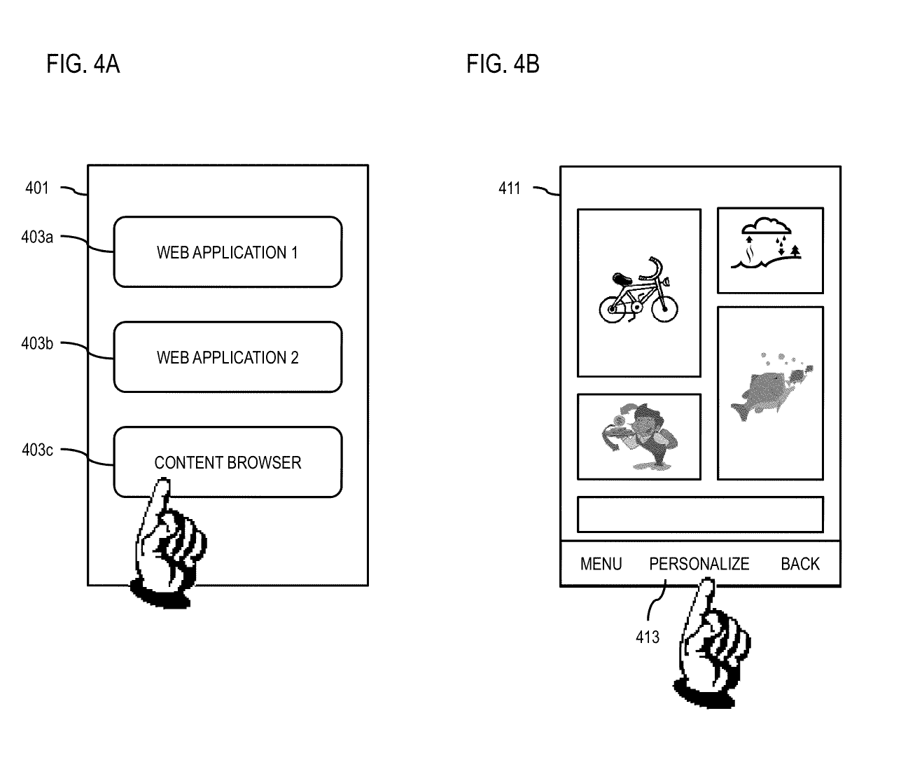

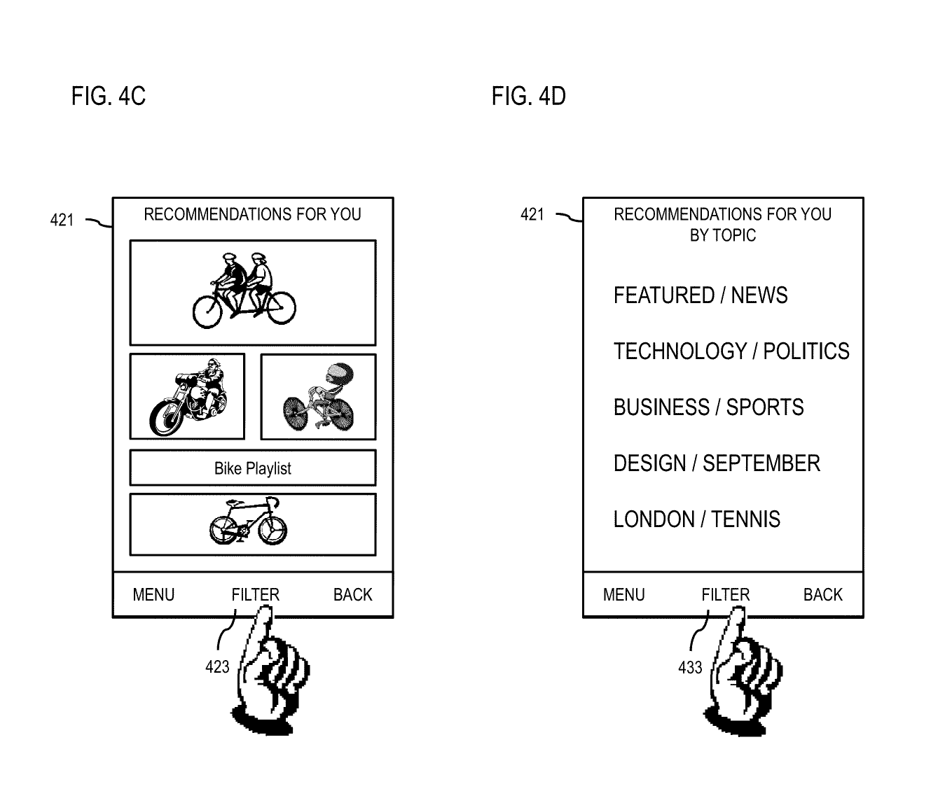

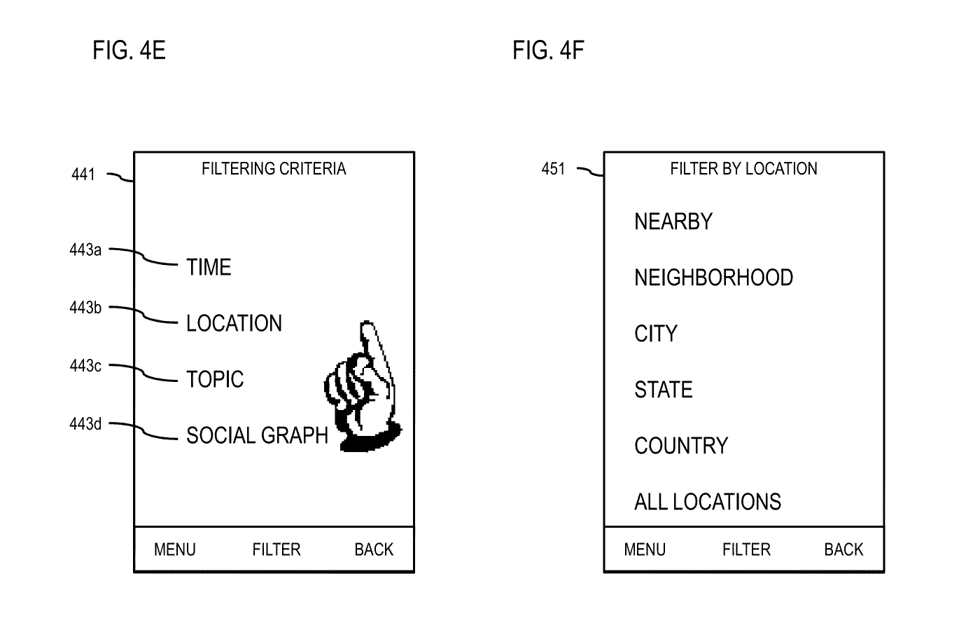

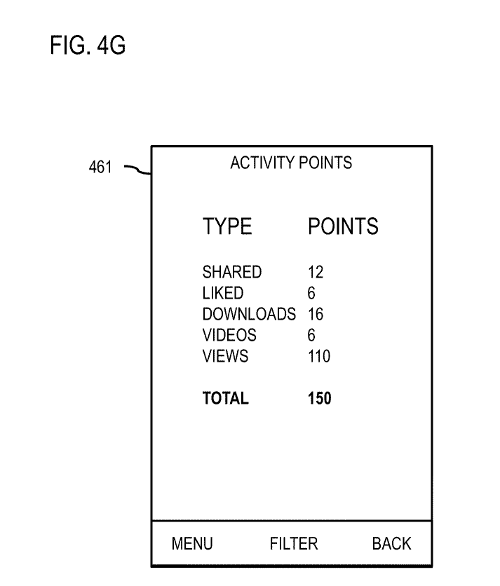

In step 313, the proxy platform 101 causes, at least in part, a delivery of the one or more recommendations to the at least one user via the proxy server. For example, content recommendations can be integrated with information provided by the proxy platform 101 to the proxy client 107 for display to the user. Examples of presentation of web content recommendation are provided below with respect to FIGS. 4A-4G.

FIGS. 4A-4G are diagrams of user interfaces utilized in the processes of FIGS. 1-3, according to various embodiments. FIG. 4A depicts a user interface 401 displaying an example home for accessing web applications 403a-403c (e.g., web application 1, web application 2, and content browser, respectively). In this example, the web applications 403a-403c have connectivity to a proxy platform 101 for tracking usage information and providing proxy-based content recommendations. In addition, the example assumes that a user has selected the content browser web application 403c to initiate.

Accordingly, as shown FIG. 4B, a user interface 411 of the content browser web application 403c is presented. User interface 411 provides a stylized representation of web content (e.g., in a magazine type format) available to the user. In this case, user interface 411 is initiated with a standard set of articles randomly selected for presentation to the user. The user interface 411 also provides an option 413 to personalize the content. In this example, personalizing the content enables to the web application 403c to make proxy-based content recommendations that can provide web content that is relevant to the user.

For example, on selecting the option 413 to personalize the web content presented in by the web application 403c, the web application 403c can display a user interface 421 of FIG. 4C presenting personalized web content recommendations. In this example, the web content application 403c personalizes or recommends web content based on output from the proxy platform 101 that has track and analyzed the usage information of the user. The user, in this case, has not actively configured the proxy platform 101 to indicate the user's preferences. Instead, the proxy platform 101 has automatically created a user profile based on usage information logged at the proxy platform 101 for the user. Based on comparing the created user profile against reference user profiles collected from other users, the proxy platform 101 determines that the most relevant web content to recommend include media and articles related to bicycles and motorbikes. User interface 421 displays the recommendations in graphical magazine format. Alternatively, the web application 403c may display the recommendations by topic as depicted in user interface 431 of FIG. 4D. In one embodiment, it is contemplated that the recommendations can include both linked web stories as well as recommended applications and/or services based on the user's usage information and/or profile.

In either case of user interface 421 or user interface 431, the web application 403c may further provide respective options 423 and 433 to filter the recommended web content according to various filtering criteria. For example, on selecting either option 423 or option 433, the web application 403c displays a user interface 441 of FIG. 4E that presents a list of filtering criteria available to the user. As shown in user interface 441, the user can select from the following filtering criteria 443a-443d: time, location, topic, and social graph connections. In this example, the user selects the filtering criterion 443b (“location”). In response, the web application 403c displays the user interface 451 that further enables the user to specify the granularity of the location filtering. For example, granularities 453a-453f are presented to represent, respectively, nearby, neighborhood, city, state, country, and all locations. Selecting on any of the granularities 453a-453f will enable the proxy platform 101 to filter the recommended results based on relevance to the respective location granularities 453a-453f.

In one embodiment, the web application 403c and/or the proxy platform 101 can further engage users in the proxy-based recommendation process by, for instance, exposing usage information as statistics through gamification. For example, as shown in user interface 461 of FIG. 4G, the web application 403c can expose various usage statistics as points in a game (e.g., the gamification of the usage statistics). For example, the usage statistics such as number shared web content items, number of liked web content items, number of web content downloads, number of videos played, and number of web page views, can be presented as point values to encourage the user to create more usage information by maximizing point values. In this way, the proxy platform 101 can increase the amount of usage data that it can process to provide more relevant proxy-based content recommendations.

The processes described herein for providing proxy-based content discovery and delivery may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

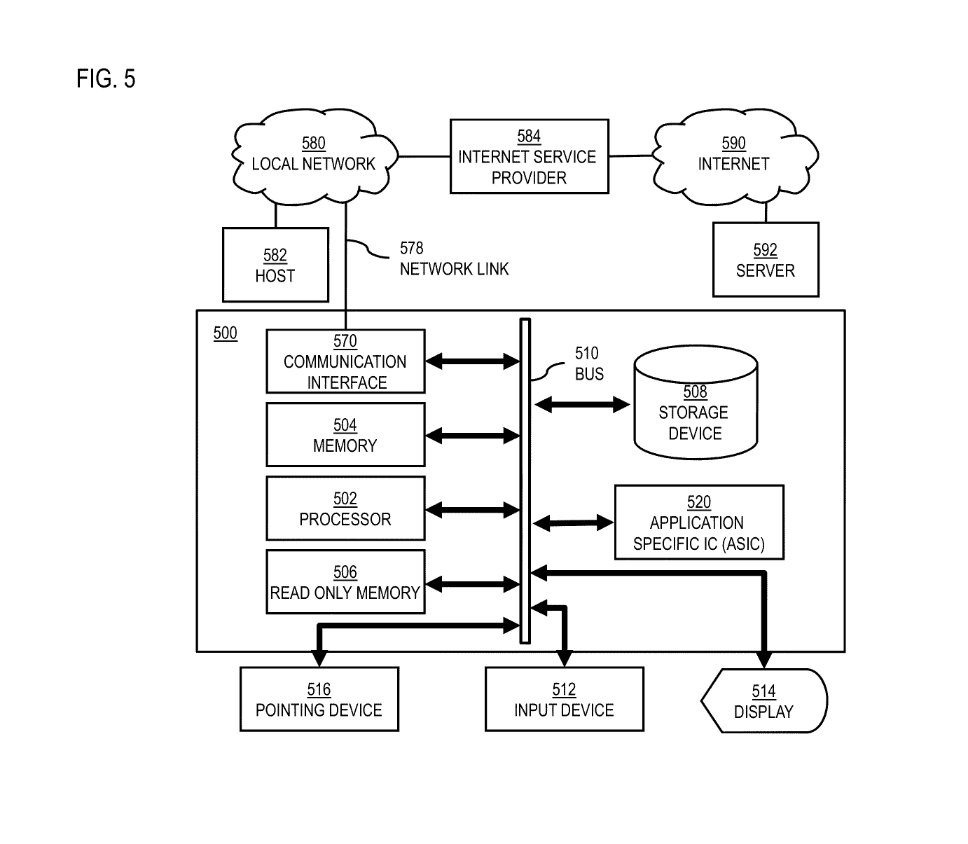

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to provide proxy-based content discovery and delivery as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of providing proxy-based content discovery and delivery.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to providing proxy-based content discovery and delivery. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for providing proxy-based content discovery and delivery. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for providing proxy-based content discovery and delivery, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 103 for providing proxy-based content discovery and delivery.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to provide proxy-based content discovery and delivery as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of providing proxy-based content discovery and delivery.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to provide proxy-based content discovery and delivery. The memory 605 also stores the data associated with or generated by the execution of the inventive steps.

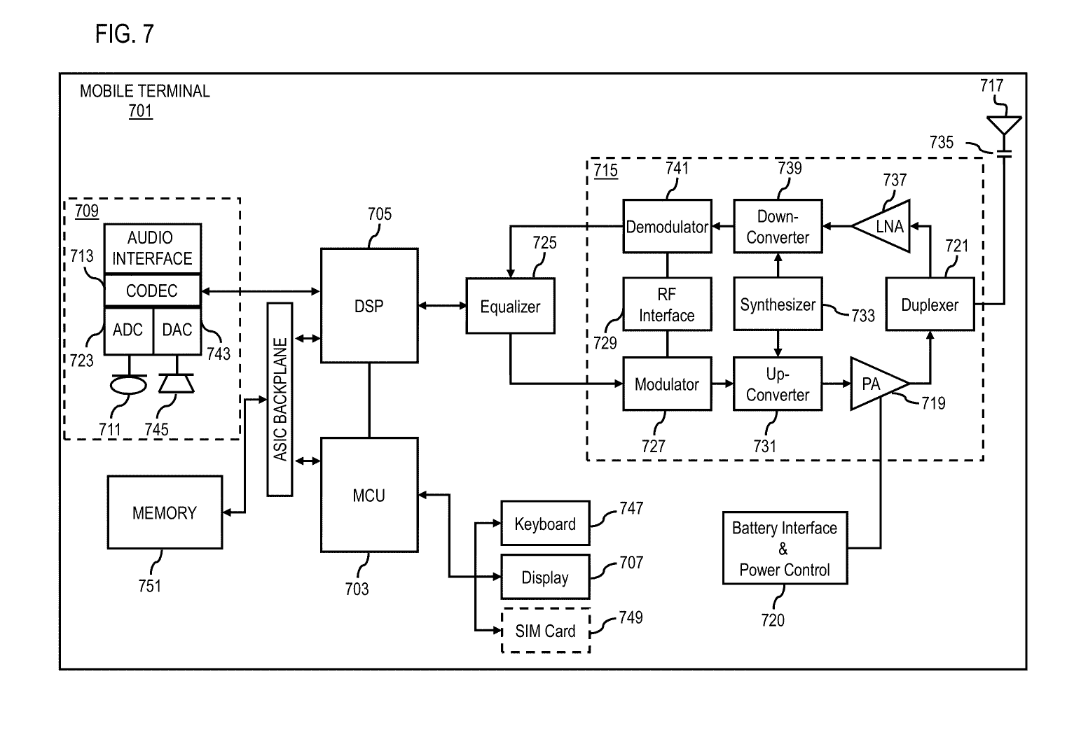

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of providing proxy-based content discovery and delivery. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of providing proxy-based content discovery and delivery. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to provide proxy-based content discovery and delivery. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of usage information for at least one user of a proxy server, wherein the usage information includes, at least in part, browser history information, web application data usage information, or a combination thereof determined by the proxy server to be associated with the at least one user;
a processing of the usage information to determine at least one user profile for the at least one user; and
at least one determination of one or more recommendations for the at least one user based, at least in part, on the at least one user profile.

2. A method of claim 1, wherein the (1) data and/or (2) information and/or (3) at least one signal are further based, at least in part, on the following:
a processing of the usage information to determine one or more user behavioral patterns, one or more user preferences, or a combination thereof with respect to web content available via the proxy server,
wherein the at least one user profile, the one or more recommendations, or a combination thereof are further based, at least in part, one or more user behavioral patterns, the one or more user preferences, or a combination thereof.

3. A method of claim 2, wherein the web content includes, at least in part, one or more web pages, one or more videos, one or more photographs, one or more audio tracks, one or more applications, or a combination thereof.

4. A method of claim 1, wherein the (1) data and/or (2) information and/or (3) at least one signal are further based, at least in part, on the following:
at least one determination of reference usage information for one or more reference users of the proxy server;
a processing of the reference usage information to determine one or more associations between the one or more reference behavioral profiles of the one or more reference users and one or more reference web content items; and
at least one determination of the one or more recommendations for the at least one user based, at least in part, on the one or more associations.

5. A method of claim 4, wherein the (1) data and/or (2) information and/or (3) at least one signal are further based, at least in part, on the following:
at least one determination of the usage information, the reference usage information, or a combination thereof based, at least in part, on one or more inputs from the at least one user, the one or more reference users, or a combination thereof.

6. A method of claim 1, wherein the (1) data and/or (2) information and/or (3) at least one signal are further based, at least in part, on the following:
a filtering of the one or more recommendations based, at least in part, on one or more filtering criteria.

7. A method of claim 6, wherein the one or more filtering criteria include, at least in part, a time criterion, a location criterion, a topic criterion, a social graph criterion, or a combination thereof.

8. A method of claim 1, wherein the (1) data and/or (2) information and/or (3) at least one signal are further based, at least in part, on the following:
a delivery of the one or more recommendations to the at least one user via the proxy server.

9. A method of claim 1, wherein the usage information represents a substantially complete log of the browser history information, the web application data usage information, or a combination thereof determined by the proxy server.

10. A method of claim 1, wherein the one or more recommendations include, at least in part, one or more applications, one or more services, or a combination thereof.

11. An apparatus comprising:
at least one processor; and
at least one memory including computer program code for one or more programs, the at least one memory and the computer program code configured to, with the at least one processor, cause the apparatus to perform at least the following,
determine usage information for at least one user of a proxy server, wherein the usage information includes, at least in part, browser history information, web application data usage information, or a combination thereof determined by the proxy server to be associated with the at least one user;
process and/or facilitate a processing of the usage information to determine at least one user profile for the at least one user; and
determine one or more recommendations for the at least one user based, at least in part, on the at least one user profile.

12. An apparatus of claim 11, wherein the apparatus is further caused to:
process and/or facilitate a processing of the usage information to determine one or more user behavioral patterns, one or more user preferences, or a combination thereof with respect to web content available via the proxy server,
wherein the at least one user profile, the one or more recommendations, or a combination thereof are further based, at least in part, one or more user behavioral patterns, the one or more user preferences, or a combination thereof.

13. An apparatus of claim 12, wherein the web content includes, at least in part, one or more web pages, one or more videos, one or more photographs, one or more audio tracks, one or more applications, or a combination thereof.

14. An apparatus of claim 11, wherein the apparatus is further caused to:
determine reference usage information for one or more reference users of the proxy server;
process and/or facilitate a processing of the reference usage information to determine one or more associations between the one or more reference behavioral profiles of the one or more reference users and one or more reference web content items; and
determine the one or more recommendations for the at least one user based, at least in part, on the one or more associations.

15. An apparatus of claim 14, wherein the apparatus is further caused to:
determine the usage information, the reference usage information, or a combination thereof based, at least in part, on one or more inputs from the at least one user, the one or more reference users, or a combination thereof.

16. An apparatus of claim 11, wherein the apparatus is further caused to:
cause, at least in part, a filtering of the one or more recommendations based, at least in part, on one or more filtering criteria.

17. An apparatus of claim 16, wherein the one or more filtering criteria include, at least in part, a time criterion, a location criterion, a topic criterion, a social graph criterion, or a combination thereof.

18. An apparatus of claim 11, wherein the apparatus is further caused to:
cause, at least in part, a delivery of the one or more recommendations to the at least one user via the proxy server.

19. An apparatus of claim 11, wherein the usage information represents a substantially complete log of the browser history information, the web application data usage information, or a combination thereof determined by the proxy server.

20. An apparatus of claim 11, wherein the one or more recommendations include, at least in part, one or more applications, one or more services, or a combination thereof.

21.-48. (canceled)
